(19) United States
(12) Patent Application Publication
(10) Pub. No.: US 2007/0201059 A1
(43) Pub. Date: Aug. 30, 2007

(54) Method and system for automatically configuring a device driver

(76) Inventors: Tim O. Radzykewycz, Clearlake Oaks, CA (US); Richard Sweeney, Tracy, CA (US)

Correspondence Address: FAY KAPLUN & MARCIN, LLP, 15O BROADWAY, SUITE 702, NEW YORK, NY, 10038, US

(21) Appl. No.: 11/365,635

(22) Filed: Feb. 28, 2006

(51) Int. Cl. G06F 3/12

(52) U.S. Cl. 358/1.9; 358/1.13

(57) ABSTRACT

Described is a system and method for defining a first time in a startup sequence of a computing system and determining first external resources that are available at the first time. A device driver then performs a first action based on the first external resources available at the first time. A second time in the startup sequence is defined and second external resources that are available at the second time are determined. The device driver then performs a second action based on the second external resources available at the second time.

### BACKGROUND

A device driver, or simply driver, is a computer program that allows an operating system (“OS”), an application program, or other software to communicate with a hardware device within a computing environment. Thus, the channel between the OS and every hardware device would need to travel through the driver. Since models of hardware devices vary, including devices within a similar class, different drivers may be used to create a connection to a new device or to provide a more reliable and better performing connection to a current device.

The function of the driver is to be a translator between the electrical signals of the subsystem of the hardware and the high-level programming languages of both the OS and/or the application programs. The driver may translate the data from an OS into streams of bits placed in a specific location on storage devices. In other words, the device may translate the OS function calls into device specific calls. By having the driver separate from the OS, new functions can be added to the driver without modifying or recompiling the OS itself. Adding a new device to a computing environment should function properly if there is a suitable driver available to allow for communication between the device and the OS. While the new device may be controlled in a new manner, the device driver will ensure that the device operates in a manner familiar to the OS.

Due to the variations in the hardware devices controlled through drivers, a driver program may operate in many different manners and will usually only operate when the device is required. The OS may assign a high priority to the drivers in order to allow for the system resources to be released and readied for further immediate usage. The present invention relates to determining the available system resources for configuring device drivers.

### SUMMARY OF THE INVENTION

A method for defining a first time in a startup sequence of a computing system and determining first external resources that are available at the first time. A device driver then performs a first action based on the first external resources available at the first time. A second time in the startup sequence is defined and second external resources that are available at the second time are determined. The device driver then performs a second action based on the second external resources available at the second time.

A system having a hardware device, a device driver to control the hardware device and a bus controller receiving data from one of the hardware device and the device driver, the bus controller converting the data to a receivable format by the other one of the hardware device and the device driver when the data is in a non-receivable format.

A method for calling, by a device driver, an access function of a bus controller to access a hardware device, determining a data format of data for which one of a read function and a write function is to be performed between the device driver and the hardware device, converting the data from the data format to a new data format when the data format is incompatible and performing the one of the read function and the write function.

A system having a plurality of hardware devices, a driver interrupt module including an entry for each of a device type of the plurality of hardware devices, each entry including an index and a corresponding interrupt function and a plurality of device drivers, each device driver corresponding to one of the hardware devices, each device driver referring to the driver interrupt index to perform interrupt functions for the corresponding hardware device.

### BRIEF DESCRIPTION OF THE DRAWINGS

FIG. 1 shows an exemplary method for automatically configuring a device driver according to the present invention.

FIG. 2 shows an exemplary operating environment for providing device drivers with board-independent access to device hardware according to the present invention.

FIG. 3 shows a method for optimizing a write function within the flags variable according to the present invention.

FIG. 4 shows a method for optimizing a read function within the flags variable according to the present invention.

FIG. 5 shows an exemplary separate module for bundling information about multiple interrupts for an exemplary high-speed network interface according to the present invention.

FIG. 6 shows an exemplary separate module for bundling information about multiple interrupts for a PCI device according to the present invention.

### DETAILED DESCRIPTION

The present invention may be further understood with reference to the following description and the appended drawings, wherein like elements are referred to with the same reference numerals. The exemplary embodiments of the present invention describe a method and system for porting an existing driver to a new platform. Specifically, the present invention relates to initializing a device and driver, providing hardware access, optimizing the routine called for device hardware access, and providing interrupt information that is independent of the accessing device driver.

Throughout this description, the terms device, device driver, device instance, and driver instance may be used. A device is defined as any piece of physical hardware attached to a computer OS by way of a bus (e.g. input/output (“I/O”) type bus, auxiliary type bus, etc.). A device driver is defined as a software module that may translate I/O requests to/from the device, thereby enabling an OS, or another software module, to interact with the device. A device instance is a profile or a specification of a physical device type. In order for a drive to communicate with a device, a device instance may be added during a driver installation routine. A device instance may be attached to a communication port of a computer OS and may act as the logical connection between the driver and the device. The creation of a device instance may assign a label to a device instance and may establish characteristic properties that may be used by the driver to communicate with the device. A driver instance may be defined as a set of one or more regions of the same driver that are associated with a particular instance of the device of the driver. The driver instance may be a runtime instantiation of a driver that runs in a process.

A bus may be any type of bus that is included in a computing environment. Examples of buses include a Peripheral Component Interconnect (PCI) bus, a PCI-Extended (PCI-X) bus, a PCI-Express bus, an Accelerated Graphics Port (AGP) bus, a CardBus, Personal Computer Memory Card International Association (PCMCIA) bus, Compact PCI bus, HyperTransport bus, RapidIO bus, Parallel bus, Processor Bus, Universal Serial Bus (USB), FireWire, VME bus, Controller Area Network (CAN) bus, Small Computer System Interconnect (SCSI) bus, Hewlett Packard Instrument Bus (HPIB), etc. The bus may also refer to wireless buses such as BlueTooth, fiber optic channels, etc. Those skilled in the art will understand that a bus in the exemplary embodiments may refer to any type of bus, even where a specific type of bus is provided. Furthermore, it should also be understood that the transmission mechanism for the signals transported on the bus is independent of the present invention, e.g., the present invention may be implemented where copper or other metallic conductors are used, where silicon conductors are used, where fiber optic conductors are used, where wireless electromagnetic signals are used, etc.

The initializing step may involve pre-defining the available external resources during several times of the system startup sequence and may provide an opportunity for each device driver instance to perform any appropriate actions. The providing hardware access step may be further defined as a bus controller providing a board-independent method for device drivers to access downstream device hardware. A bus controller may be understood to mean a component of a computer's bus system that allows for communication commands between a CPU and various devices within a computer operating environment. The optimizing step may make use of a method for tracking the data format and data conversion operations for increased performance of the device drivers. Finally, the providing interrupt information step may be further defined as bundling interrupt information into a separate, device-independent module (i.e., consistent across all device drivers) that is capable of performing interrupt-related operations through reference to an independent module performing the mapping of interrupt vectors, interrupt request lines (“IRQs”), and other processor-specific implementations of interrupts. An IRQ may be a bus line used to signal an interrupt.

Standard device and driver initialization processes require a developer of a device driver to determine which external resources are required. Additionally, this process is performed on an ad-hoc basis. According to a preferred embodiment, the present invention may pre-define the external resources several times during a system startup sequence. At each of the pre-defined times, each device and driver instance may be provided an opportunity to perform any appropriate actions. Thus, drivers can be written to be independent of the particular board support package (“BSP”). A BSP may be defined as a bootable OS within an embedded device. By having a driver independent to a BSP, device and driver initialization would no longer require ad-hoc BSP code, thereby allowing for a more efficient port of an exiting driver to a new platform.

The prior art methods for device drivers to access device hardware would force the device driver to be non-portable. These methods may be including all necessary configuration information in the driver itself, or providing a separate module for each driver that is specific to the hardware platform. Inclusion of all necessary information specific to the hardware platform in the driver results in a non-portable driver, which can be used only on the specific hardware platform. The creation of separate modules for each combination of hardware platform and driver causes the device drivers to be non-portable. The exemplary embodiments of the present invention eliminate the need for driver support modules. By abstracting the hardware access to provide board-independent methods for device drivers to access downstream device hardware.

In the exemplary embodiments of the present invention, basic device access in a device driver uses a flags variable to track data order and allows for data conversion by each of the bus controller device drivers between the CPU and the device, wherein a function call is made for each bus between the CPU and the device. Thus, the operations performed on the data must be tracked and the results may be saved in the flags variable. According to exemplary embodiments of the present invention, optimization of driver access functionality allows for higher performance of portable device drivers when the device drivers access the device hardware. This embodiment may use the flags variables for tracking data format and for data conversion operations. Thus, the present invention may allow the routines called for device hardware access to be optimized, eliminating any overhead associated with both the multiple function calls and the tracking the data transformation.

The current art for connecting multiple interrupts generated by a single device can be accomplished with one of two methods. The first method would be to make the device driver dependent on the hardware configuration where the driver is put into use. However, this method limits both the portability and reusability of the source code for the device driver. The second method would be to separate the device driver into two components, wherein one component contains the core device control modules and the other component contains instructions for accessing the hardware. However, this method requires the hardware access module to be written for each platform on which the device driver is used. Thus, like the first method, the second method would make it difficult to port a device driver to a new hardware device.

According to exemplary embodiments of the present invention, information about interrupts may be bundled into a separate module. This separate module may be independent of the device and, thus, may be utilized for all device drivers. Therefore, the present invention eliminates the dependency need that the device drivers may have on the individual hardware. Since the present invention may be consistent across all device drivers, there are no additional modules required in order to allow for a new driver to operate on any platform that supports any other device driver that is utilizing the present invention. The bundling of interrupt information will be described in greater detail below.

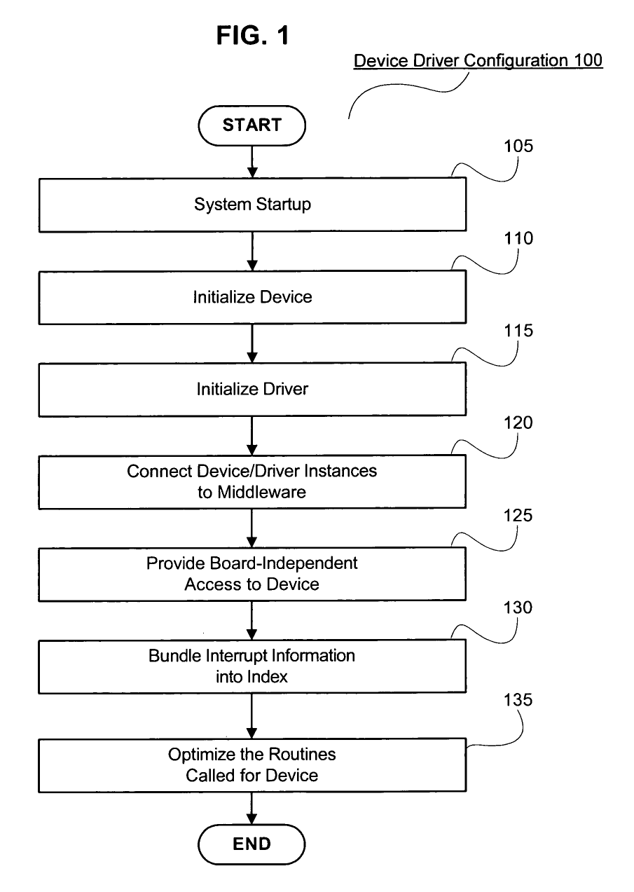

FIG. 1 shows an exemplary method 100 for automatically configuring a device driver according to the present invention. In general, the method 100 begins with the format for initializing a driver and a device, wherein step 105 may be initiating system startup sequence. As discussed above, the method 100 may pre-define an OS at several pre-defining times during the system startup sequence of the OS, where the OS includes OS facilities, middleware facilities, and application facilities. The term pre-define may be understood to mean the act of defining the available external resource of a system. At each of the pre-defining times, each of the driver and device instances may be provided with the opportunity to perform actions appropriate to the time. The actions perform may include calling an appropriate driver routine to manage the data flow and communication between a hardware device and an OS or a software program.

The pre-defining times may take place during the OS start up (or initiation) sequence, and the times may include device initialization 110, driver initialization 115, and device/driver instance connection 120. Those of skill in the art will understand that each of these times are only exemplary and that a developer may select additional (or less) pre-defining times based on the particular design of the computing system.

Upon the powering-up of the system and the initializing of the CPU, a first pre-defining time may take place at the device initialization step 110 where the OS facilities may not yet be available. Following step 110, the basic OS facilities may be initialized. A second pre-defining time may take place at the driver initialization step 115, during which many of the basic OS facilities may be available, however the middleware and application facilities may not yet be available. Following step 115, the remaining board-specific features of the OS may be initialized. A third pre-defining time may take place at the device/driver instance connection step 120, where each of the device and driver instances have been initialized and thus, the instances may be provided the opportunity to make themselves available to middleware and application modules.

Therefore, the initialization method of the exemplary embodiments of the present invention allow for a series of pre-defining times during a system initialization sequence wherein the external facilities available to the OS may be defined during the device and driver initialization sequence and during the device/driver instance connection. At each of these times, a device/driver instance may call an appropriate driver routine to provide a uniform interface between the OS and a device. Thus, the driver initialization steps 110-120 may allow for one or more drivers to be written independent of any particular BSP, as opposed to writing on an ad-hoc basis. In other words, this method eliminates the need for device driver developers to determine external facilities and modify the system initialization sequence in order to account for the initialization of a newly added device. Additionally, the method may also reduce the time required to port an existing driver onto a new platform.

In step 125 of the exemplary method, the present invention may abstract the hardware access allowing the device drivers to be provided with board-independent access to device hardware (e.g. device registers). As discussed above, the present invention may eliminate the need for driver support modules. Since separate modules specific to the hardware platform need to be created for each combination of BSP and driver, the device drivers are rendered non-portable. As opposed to having all of the access information on a device driver or having a plurality of driver support modules based on the product of BSPs and drivers supported, step 125 of the exemplary method allows for a bus controller device driver to provide the device drivers with access to downstream device hardware. The bus controller device driver may be defined as a new software entity for providing information about accessing device hardware for each bus type on the system. Once the bus controller device driver and the supporting bus type specific modules for a particular bus controller have been programmed, thus the present invention is able to provide hardware access to all devices on a particular bus by including only the bus controller device driver on the BSP. In addition, this step 125 may utilize flags to track the current data format as well as the operations performed on the data.

Traditionally, there are two areas of functionality required for a BSP to provide access to a device, namely the control of the bus controller and the service allowing the device drivers to access device hardware. Under this traditional design, the bus control functionality would be provided as a single module in every BSP supporting the bus controller device, while the device access functionality would be provided by a driver-specific module in every BSP supporting the device on the bus. Therefore, in a traditional system having two BSPs to provide access to two devices that use the same bus controller device, six software modules would be required in addition to two device drivers. One module would be required for the first BSP to control the bus control device. Two modules would be required for the first BSP to control each of the two devices. Finally, the remaining three modules would be required by the second BSP for the same purposes as the first BSP. It is important to note that the number of required modules in a traditional system would exponentially increase as the number of BSPs and device driver increase. Furthermore, the traditional system would also include the actual device drivers for each of the devices within the system.

According to a preferred embodiment of the present invention, in step 125 the management of the bus controller and the functionality of the downstream device access may be consolidated into one module. Regardless of the number of BSPs involved in a system, one bus controller device driver for the bus controller and one driver for each of the downstream devices may be used. Thus, only a fixed number of devices and some common infrastructure modules may be required within the system, eliminating the need for BSP-specific driver support module. The structure of the bus controller software modules and the use of flags will be discussed in further details below.

In step 130 of the exemplary method, the present invention may bundle information about interrupt information into a separate module, wherein the separate module is not device dependent and may be used for all device drivers. While the traditional methods for connecting multiple interrupts generated by a single device made it difficult to port a device driver to new device hardware, the exemplary embodiments of the present invention eliminate the dependency of the device driver on the individual hardware. Since the exemplary embodiments allow for consistency across all device drivers, there are no additional modules required in order to allow for a new driver to operate on a platform that supports any other device driver using this invention.

The device drivers may view interrupts as an ordered set of bus controller interrupt objects corresponding to the interrupt functionality provided by the device. In order to perform interrupt-related operations, a device driver refers to the interrupts only as an index into that ordered set, wherein the index may be constant for a device type. As discussed above, the management of interrupt vectors, IRQs, and other processor-specific implementations of interrupts may all be handled by the bus controller, and may be irrelevant to the device drivers.

In other words, the device driver may only be required to know information pertaining to the index for each instance of a device. While the mapping onto vector, IRQs, and other processor-specific implementations may be performed by a separate module (the index). Therefore, step 130 of the exemplary method allows for the connecting of multiple interrupts generated by a device while allowing for the portability and reusability of device driver source code. A device-independent method of bundling interrupt information that is consistent across all device drivers means that a device driver is no longer dependent on the configurations of individual hardware.

In step 135 of the exemplary method, the present invention may optimize the functionality of the driver access to the device hardware. As discussed above, the use of a flags variable for tracking data order and converting data during traditional device access in a bus controller device driver would require a function call to be made for each bus between a device and a CPU. This traditional device access may require additional resources in order to track the operations performed on the data and to save the results in the flags variable. However, according to step 135, the present invention allows for the routines called for device hardware access to be optimized in the sense that the resources for multiple function calls and for tracking the data transformations may not be required. This step 135 may be accomplished by making use of the flags variable that tracks data format and data conversion operations. Specifically, the flags variable may perform a read transaction and a write transaction, the processes of which will be discussed in further details below. It is important to note that the flags variable may include a value containing information about the transformations that have been applied.

After the transactions have been performed by an optimizing function, the value of the flags variable may be optimized. Specifically, this function may verify whether a global routine is available to perform the required data transformation. Wherein, if such a global routine is available, then the routine may be installed for a subsequent use by the calling driver. Thus, the optimizing step 135 may increase the performance of portable bus controller device drivers.

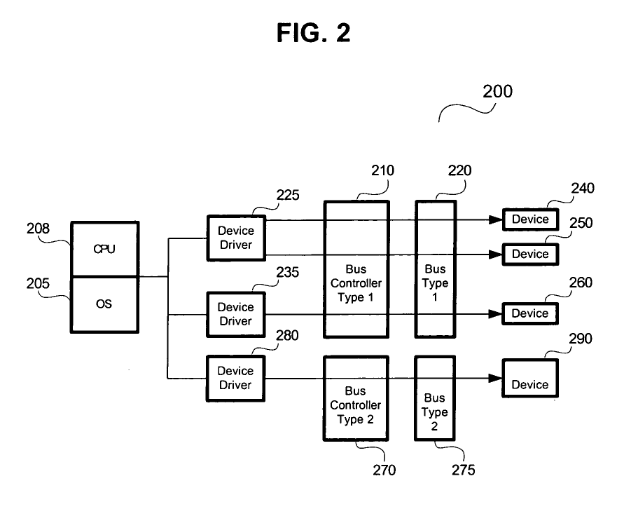

FIG. 2 shows an exemplary operating environment 200 for providing device drivers with board-independent access to device hardware according to the present invention. Those of skill in the art will understand that the description of FIG. 2 describes the steps 125 and 130 of the method 100 described with reference to FIG. 1 in more detail. According to exemplary embodiments of the present invention, the operating environment 200 includes a CPU 208 executing an OS 205 and further includes a plurality of device drivers 225, 235, wherein the device drivers may contain access functions. Device driver 225 may have access to a plurality of devices 240, 250 by way of a bus controller software module 210 and a computer bus 220. Device driver 235 may have access to device 260 by way of the bus controller 210 and the computer bus 220. The devices 240, 250, 260 may be device of a first type (e.g., peripheral component interconnect (“PCI”) devices). Thus, the bus controller 210 and computer bus 220 will be of the same type as the devices (e.g., PCI bus controller and PCI bus, respectively).

Those of skill in the art will understand that the representation of the operating environment 200 is only used for illustrating the exemplary embodiments of the present invention. The CPU 208, bus 220 and devices 240-260 are hardware devices, while the OS 205, device drivers 225, 235 and bus controller 210 are software components. The CPU 208 will obviously execute the other software components such as the device drivers 225, 235, etc. Thus, FIG. 2 is not meant to be a comprehensive representation of the interactions between various hardware and software components in an operating environment.

As discussed above, the exemplary embodiments of the present invention allow for the bus controller management and downstream device access functionality to be consolidated into a single module, the bus controller software module 210. When performing the device access, the drivers 225, 235 may not be aware of the data format required by the intervening computer bus 220. Thus, a flags variable may be used to track the current data format and the operations performed on the data. Specifically, the flags variable is passed among the access functions of the bus controller 210 and the device drivers 225, 235 which may keep track of the byte order, the operations performed on the data, and any other information that may be required. In this manner the device drivers 225, 235 according to the exemplary embodiments of the present invention do not need to separately know and/or store this information for downstream devices/buses, thereby allowing for a more efficient process of porting device drivers to new platforms.

For example, PCI device 240 resides on a little-endian PCI bus 210 and the CPU 208 may use big-endian byte order. Thus, in this example, the bytes in any transaction between the device 240 and the CPU 208 need to be swapped in order for proper communication. However, the device driver 225 does not know the data format (e.g. little-endian) required by the PCI bus 220. The access functions provided by the bus controller 210 may utilize the flags variable to keep track of the current byte order and the operations performed on the data in any transaction. Thus, when the device driver 225 makes any access to the device 240, the device driver 225 may provide a flag variable 215 for use by the access functions of the bus controller 210. A pointer to the flags variable 215 may be passed to the access functions, wherein the access functions may use the flags variable to track the data format as well as the operations performed on the data.

FIG. 2 also shows that the exemplary operating environment may also include additional types of devices, buses and controllers. In this example, the second type of device may be a virtual machine environment (“VME”) device 290 allowing for a VME bus controller 270 to consolidate the bus controller management along with the downstream device access functionality for this device 290 or any other device of the same type. A device driver 280 residing within OS 205 may have access to a VME device 290 by way of the VME bus controller 270 and a VME computer bus 275. The functions performed in the same manner described above for the embodiment containing a PCI device, as described above. The example of FIG. 2 shows that the present invention allows for a single bus controller to provide access to all devices residing on a specific bus type, thereby allowing the device drivers to be more abstract contributing to the portability of the drivers. That is, there may be many other bus controllers included in the operating environment based on the a number and different types of connected hardware devices.

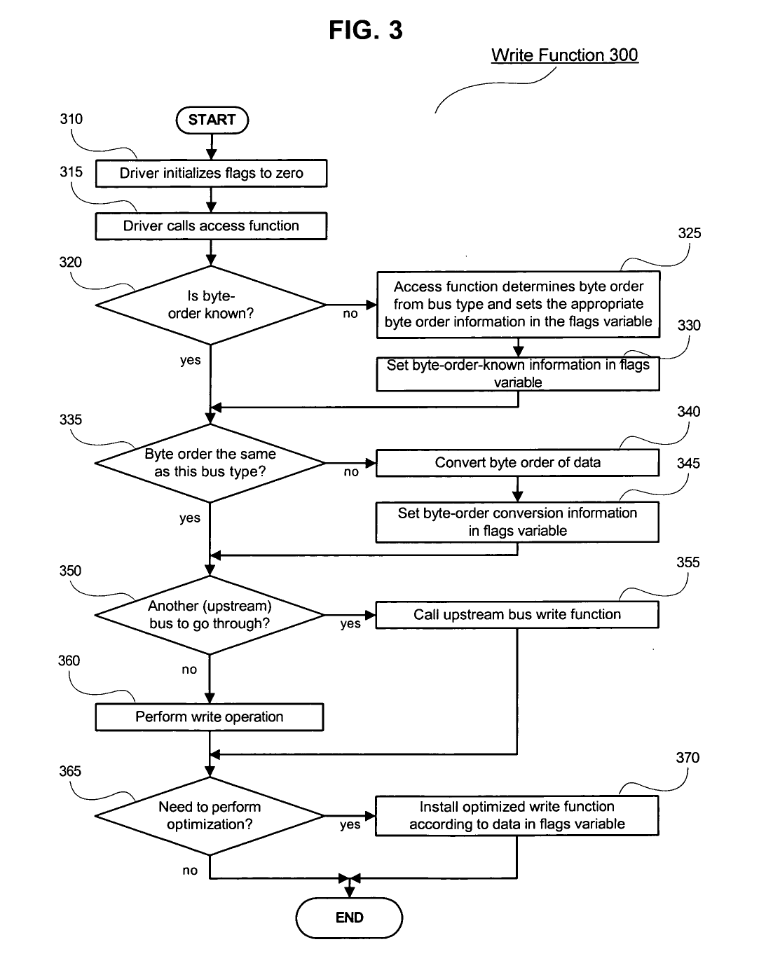

FIG. 3 shows a method 300 for optimizing a write function within the flags variable according to the present invention. As discussed above, the flags variable may be used to track data format and data conversion operations. In this example, the write function 300 is used to determine the byte order, but those of skill in the art will understand that the method 300 may be modified accordingly to handle other data format operations or other types of operations. Examples of other data format operations include interleaving and bit reversal, while examples of other non-format operations include a CPU pipe flush, I/O space operations, address mapping and address manipulation. In step 310, a driver may initialize the flags to zero or any other initial value (e.g. driver 225). The driver may then call an access function residing in a bus controller to access a device (e.g. bus controller 210 and device 240). In step 320, a determination may be made as to whether the byte-order is known. If the byte-order is unknown, then in step 325 the access function may determine the byte-order from a bus type and may set the appropriate byte-order information in the flags variable. Upon completion of step 325, in step 330 the access function may set a byte-order-known information in the flags variable (e.g., by setting a bit). Alternatively, if the byte-order is known, then the process may omit steps 325 and 330.

In step 335, a determination may be made as to whether the byte-order is the same as the current bus type. If the byte-order is not the same, then in step 340 the access function may convert the byte-order of the data, i.e., convert the data to the byte order of the current bus. Upon completion of step 340, in step 345 the access function may set byte-order-conversion information in the flags variable, thereby indicating that the byte order of the original data has been converted into a different byte order. Alternatively, if the byte-order is the same as the current bus type, then the process may omit steps 340 and 345.

In step 350, a determination may be made as to whether there is a further upstream bus. For example, there may be more than one intervening bus between the bus controller and the device. Thus, the access function needs to account for each bus by performing the corresponding write operation for each intervening bus. If there is a further bus, in step 355 the write function of the upstream bus may be called. Alternatively, if there is not another bus, in step 360 the write operation may be performed.

Finally, a determination in step 365 may be made as to whether there is a need to perform optimization on the write function to increase the functionality of the device drivers. As described above, the flags variable may be used to track data format and data conversion operations by each bus controller device driver between the CPU and the device. A call function is made for each bus between the CPU and the driver. Once the operation is performed, the value of the flags variable may now include information about this transformation in addition to all the transformations that have been previously applied. By using the cumulative information in the flags variable, later functions that perform the exact same transformation can be optimized by installing the available routine for subsequent use by the calling driver. Therefore, if there is a need to optimize the write function, in step 370 an optimized write function may be installed according to the data within the flags variable and the process is complete. Alternatively, if there is no need to perform optimization, then the process may omit step 370 and would be complete.

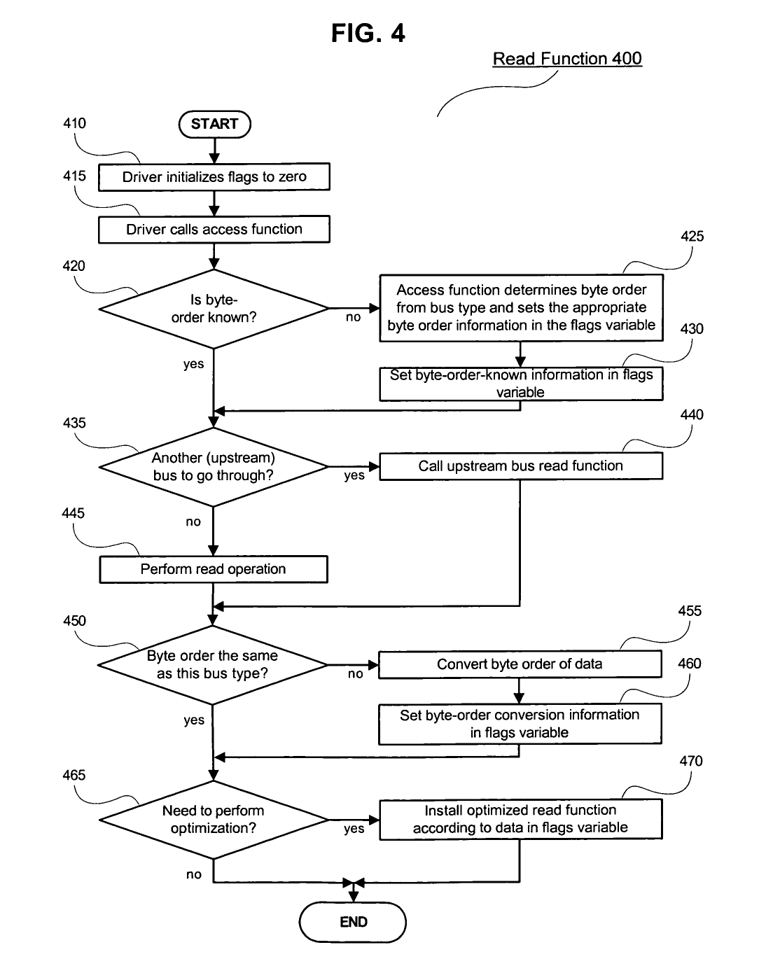

FIG. 4 shows a method 400 for optimizing a read function within the flags variable according to the present invention. In step 405, the present invention may start the read transaction process. Again, the read function will be described with respect to byte order, but other data formats or conversion operations will be similar. Analogous to the write transaction process, a driver may initialize the flags to zero or any other initialized value (step 410), and then the driver may call an access function 415. In step 420, a determination may be made as to whether the byte-order is known. If the byte-order is unknown, then in step 425 the access function may determine the byte-order from a bus type and may set the appropriate byte-order information in the flags variable. Upon completion of step 425, in step 430 the access function may set a byte-order-known information in the flags variable. Alternatively, if the byte-order is known, then the process may omit steps 425 and 430.

In step 435, a determination may be made as to whether there is a further upstream bus as described with reference to the write function of FIG. 3. If there is a further bus, in step 440 the read function of the upstream bus may be called. Alternatively, if there is not another bus, in step 445 the read operation may be performed. In step 450, a determination may be made as to whether the byte-order is the same as the current bus type. If the byte-order is not the same, then in step 455 the access function may covert the byte-order of the data. Upon completion of step 455, in step 460 the access function may set byte-order-conversion information in the flags variable. Alternatively, if the byte-order is the same as the current bus type, then the process may omit steps 455 and 460.

Finally, a determination in step 465 may be made as to whether there is a need to perform optimization on the read function to increase the functionality of the device drivers. Similar to the write function optimization step 365 of method 300 as described in FIG. 3, read functions that perform the exact same transformation can be optimized by installing the available routine for subsequent use by the calling driver through the use of the information in the flags variable. If there is a need to optimize, in step 470 an optimized read function may be installed according to the data within the flags variable and the process is complete. Alternatively, if there is no need to perform optimization, then the process may omit step 470 and would be complete.

As described above, exemplary embodiments of the present invention may bundle information about multiple interrupts generated by single device into a separate module. Specifically, this separate module may be an index which is constant for a device type and is not device dependent. Thus, the index may be used for all device drivers. A device driver may view interrupts as an ordered set of bus interrupt objects corresponding to the interrupt functions provided by the device. The device driver may refer to the interrupt objects via an index into the ordered set in order to perform an interrupt-related operation. The device driver would only need to know the index. Other functions such as mapping onto interrupt vectors, IRQs, and other processor-specific implementations may be managed and performed by a bus access function layer. Thus, these functions may be irrelevant to the device driver and the dependency of the device driver on the individual hardware configuration may be eliminated.

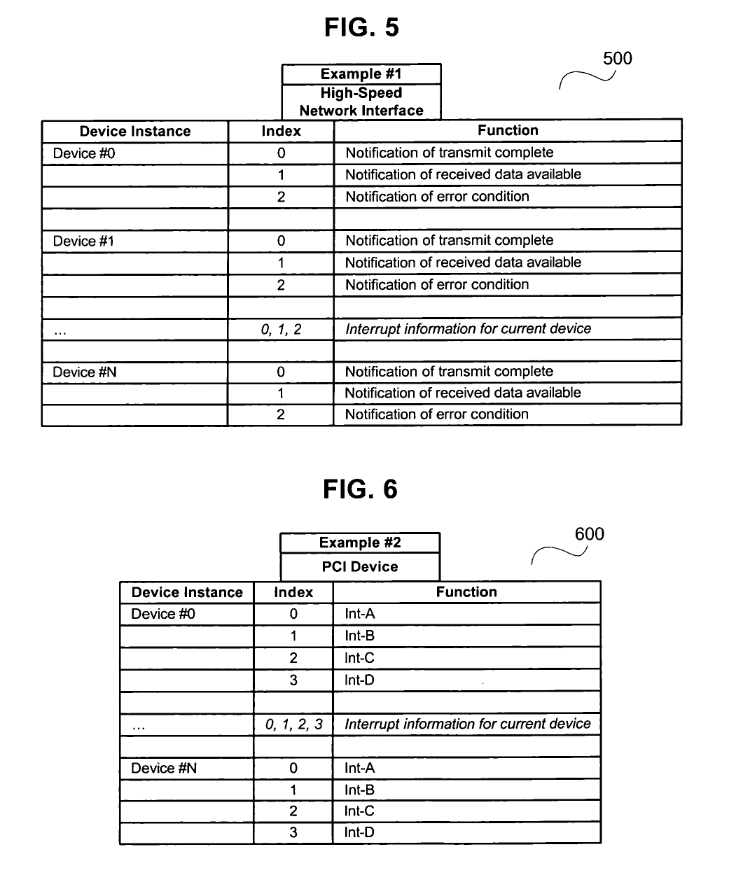

FIG. 5 shows an exemplary separate module 500 for bundling information about multiple interrupts for an exemplary high-speed network interface according to the present invention. Module 500 may represent an index table that allows a device driver to view interrupts as an ordered set of interrupt objects corresponding to interrupt functionalities provided by a high-speed network interface. For each of the device instances (devices #0-#N), an ordered set of index numbers (0, 1, 2) may be used to represent various interrupt-related functions performable by the exemplary device. In order to perform the function, the device driver may only need to refer to interrupts as the ordered set on module 500. According to this exemplary separate module 500, each of numbers (0, 1, 2) may contain unique interrupt information for the current exemplary device, a high-speed network interface. Specifically, index number 0 may represent “Notification of transmit complete;” index number 1 may represent “Notification of received data available;” and index number 2 may represent “Notification of error condition.” Therefore, the ordered set of numbers may be constant between each instance of the exemplary device (the high-speed network interface), thereby allowing the ordered set to be independent of the device and thus, used for all device drivers. This consistency across all device drivers may eliminate the need for any additional modules in order to get a new driver working on any platform that supports any other device driver using the design of the exemplary embodiments of the present invention.

FIG. 6 shows an exemplary separate module 600 for bundling information about multiple interrupts for a PCI device according to the present invention. Similar to module 500, module 600 may represent an index table that allows a device driver to view interrupts as an ordered set of interrupt objects corresponding to interrupt functionalities provided by a PCI device. For each of the device instances (devices #0-#N), an ordered set of index numbers 0, 1, 2 and 3 may be used to represent various interrupt-related functions. As described above, the device driver may only need to refer to interrupts as the ordered set on module 600 in order to perform the function. According to this exemplary module 600, each of numbers (0, 1, 2, 3) may contain unique interrupt information for the current exemplary device, a PCI device. Specifically, index 0 may represent “Int-A;” Index 1 may represent “Int-B;” Index 2 may represent “Int-C;” and Index 3 may represent “Int-D.” Thus, similar to module 500, module 600 allows for the dependency of a device driver on the individual hardware configuration for a PCI device is eliminated.

While the exemplary embodiments of the present invention describe various methods and manners of porting an existing driver to a new platform, those of skill in the art will understand that the principles and functionalities described herein may be performed in a software program, a component within a software program, a hardware component, or any combination thereof. One example would be a set of instructions stored on a computer readable storage medium (e.g. memory) executable by a processor, where the set of instructions may perform the various methods and manners according to exemplary embodiments of the present invention.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
defining a first time in a startup sequence of a computing system;
determining first external resources that are available at the first time;
performing, by a device driver, a first action based on the first external resources available at the first time;
defining a second time in the startup sequence;
determining second external resources that are available at the second time; and
performing, by the device driver, a second action based on the second external resources available at the second time.

2. The method of claim 1, further comprising:
defining a third time in the startup sequence;
determining third external resources that are available at the third time; and
performing, by the device driver, a third action based on the third external resources available at the third time.

3. The method of claim 1, wherein the first action is initialization of the device driver.

4. The method of claim 1, wherein the first time is before operating system facilities of the computing system are available during the startup sequence.

5. The method of claim 1, wherein the second time is after operating system facilities of the computing system are available during the startup sequence.

6. The method of claim 1, wherein the second time is after at least one of a middleware facility and an application facility is available.

7. A system, comprising:
a hardware device;
a device driver to control the hardware device; and
a bus controller receiving data from one of the hardware device and the device driver, the bus controller converting the data to a receivable format by the other one of the hardware device and the device driver when the data is in a non-receivable format.

8. The system of claim 7, wherein the data is in a non-receivable format based on a bus interposed between the device driver and the hardware device.

9. The system of claim 8, wherein the bus is one of a Peripheral Component Interconnect (PCI) bus, a PCI-Extended (PCI-X) bus, a PCI-Express bus, an Accelerated Graphics Port (AGP) bus, a CardBus, a Personal Computer Memory Card International Association (PCMCIA) bus, a Compact PCI bus, a HyperTransport bus, a RapidIO bus, a Parallel bus, a Processor Bus, a Universal Serial Bus (USB), a FireWire, a VME bus, a Controller Area Network (CAN) bus, a Small Computer System Interconnect (SCSI) bus, a Hewlett Packard Instrument Bus (HPIB), a BlueTooth bus, and a fiber optic channel.

10. The system of claim 7, wherein the data is in a non-receivable format based on a plurality of buses interposed between the device driver and the hardware device.

11. The system of claim 7, wherein the format of the data is tracked using a variable.

12. The system of claim 7, wherein the converting includes one of converting a byte order of the data, interleaving the data, bit reversal of the data, a CPU pipe flush, an I/O space operation, address mapping and address manipulation.

13. A method, comprising:
calling, by a device driver, an access function of a bus controller to access a hardware device;
determining a data format of data for which one of a read function and a write function is to be performed between the device driver and the hardware device;
converting the data from the data format to a new data format when the data format is incompatible; and
performing the one of the read function and the write function.

14. The method of claim 13, further comprising:
optimizing a converting function for converting the data, wherein the optimizing is based on a plurality of conversions being performed on the data.

15. The method of claim 13, wherein the data format is one of a byte order of the data, interleaving of the data and bit reversal of the data.

16. The method of claim 13, wherein the determining the data format includes:
reading, by the access function, a variable in the device driver, the variable corresponding to the data format.

17. The method of claim 13, wherein the determining the data format includes:
determining, by the access function, a bus type of a bus interposed between the device driver and the hardware device.

18. The method of claim 13, further comprising:
tracking the conversions of the data via a variable stored in the device driver.

19. A system, comprising:
a plurality of hardware devices;
a driver interrupt module including an entry for each of a device type of the plurality of hardware devices, each entry including an index and a corresponding interrupt function; and
a plurality of device drivers, each device driver corresponding to one of the hardware devices, each device driver referring to the driver interrupt index to perform interrupt functions for the corresponding hardware device.

20. The system of claim 19, wherein the driver interrupt module is further configured to one of map interrupt vectors and provide interrupt request lines (“IRQs”).
